(19) United States
(12) Patent Application Publication
(10) Pub. No.: US 2024/0112482 A1
(43) Pub. Date: Apr. 4, 2024

(54) METHOD AND APPARATUS FOR TEXT RESTORATION IN CHARACTER RECOGNITION

(71) Applicant: KONICA MINOLTA BUSINESS SOLUTIONS U.S.A., INC., Foster City, CA (US)

(72) Inventor: Junchao WEI, San Mateo, CA (US)

(21) Appl. No.: 17/958,232

(22) Filed: Sep. 30, 2022

(51) Int. Cl. G06V 30/19; G06V 10/82

(52) U.S. Cl. CPC G06V 30/19147; G06V 10/82; G06V 30/1916

(57) ABSTRACT

Aspects of the present invention provide, in an optical/image character recognition (OICR) system comprising an OICR engine and a machine learning system, a method of training the machine learning system involving generation of degraded data for use in training the machine learning system. Other aspects of the present invention provide, in a similar OICR system, a method of restoring degraded end user data. Other aspects provide the OICR systems which function as described.

### CROSS-REFERENCE TO RELATED APPLICATION

The present application is related to U.S. application Ser. No. 17/491,122, filed Sep. 30, 2021, entitled “Method and Apparatus for Customized Deep Learning-Based Text Correction”. The entire contents of the just-referenced application are incorporated by reference herein.

### FIELD OF THE INVENTION

Aspects of the present invention relate to image processing, and more particularly, to character recognition.

### BACKGROUND OF THE INVENTION

Printed end user data can contain damaged and/or degraded characters (for example, smeared, smudged, blurry, bleeding, or partially missing letters or numbers). Such characters can arise for a number of reasons, from scanning errors to moisture or other extraneous material on the documents, among other things. Any of these problems presents a challenge in optical character recognition (OCR) or image character recognition (ICR). It can be challenging to retrain or finetune a character recognition system to address such errors. For example, there may be a limited number of examples with which to do the retraining or the finetuning. There also may be a concern that training data can be biased, resulting in decreased performance and/or drift after the retraining or finetuning. To avoid such issues, larger training sets can be employed, but these can cost a lot of time and money, not only in terms of running the training sets, but also in terms of the time to generate and check the training sets. Augmenting existing data sets also can result in drift and/or bias.

### SUMMARY OF THE INVENTION

In view of the foregoing, in one aspect, embodiments of the invention provide an approach to data generation and restoration involving character data. In an embodiment, issues in Japanese or more general East Asian character data generation and restoration are addressed, by creating data to train a machine learning (ML) system which can operate in conjunction with an optical/image character recognition (OICR) engine as part of an overall OICR system, wherein the OICR engine reads certain types of data, and the ML system reads data which may be more specialized. Having the ML system and the OICR engine operate together can avoid having to perform substantial retraining or fine tuning of the OICR engine.

In an embodiment, the ML system comprises a convolutional neural network (CNN) which generates characters containing defects, and a recursive neural network (RNN) which identifies and corrects characters with defects. In an embodiment, the overall CRNN system comprises a generative network model that learns and recognizes low level noisy patterns and differentiates them from higher level content. In an embodiment, the characters and fonts with which the CRNN system work may be specific to an end user, while the characters and fonts with which the OICR engine works may be more general. In an embodiment, the OICR engine may be referred to as a base model, and the CRNN system may be referred to as an end user model. In an embodiment, the OICR engine also may be an ML system. In an embodiment, the OICR engine may operate with multiple CRNN systems for different end users.

There are two main areas of application for this generative network model, in the context of optical and image character recognition. One is in data generation, to generate training sets for the CRNN system. For data generation, the generative network is applied to generate characters with a variety of defects, for example, missing characters or portions of characters, or blurry characters. Another is in image restoration, to clean data and reduce noise in the data. For image restoration, the generative network is applied to recover heavily damaged characters with particular fonts, for example, characters with merged or missing strokes, or characters that are blurred or smudged, and to remove background noise. In an embodiment, the fonts and background noise may be specific to an end user. Accordingly, the CRNN may be trained on data that is specific to an end user. By training the CRNN with this data instead of the OICR engine, it is possible to avoid skewing or biasing the OICR engine with end user data that may be extreme, or very different from other training data used for the OICR engine.

Another area of application of the generative network model is in generating an end user model to enable recognition of heavily damaged text. For the end user model, a trained discriminator also can be used as a sub-model, and can be applied to recognize different types of degradation in end user samples.

### BRIEF DESCRIPTION OF THE DRAWINGS

Aspects of the invention now will be described with reference to embodiments as illustrated in the accompanying drawings, in which:

FIGS. 1A and 1B are high level diagrams of flow within different neural networks, constituting a CRNN system in accordance with an embodiment;

FIGS. 2A and 2B show examples of data generation in accordance with an embodiment, while FIGS. 2C and 2D show examples of data restoration in accordance with an embodiment;

FIGS. 3A and 3B, and FIGS. 3C and 3D are further examples of data restoration in accordance with an embodiment;

FIGS. 4A-4C show another example of data restoration in accordance with an embodiment;

FIGS. 5A-5C show another example of data restoration in accordance with an embodiment;

FIGS. 6A-6C show another example of data restoration in accordance with an embodiment;

FIGS. 7A-7C show another example of data restoration in accordance with an embodiment;

FIGS. 8A-8C show another example of data restoration in accordance with an embodiment;

FIGS. 9A-9C show another example of data restoration in accordance with an embodiment;

FIG. 10 is a flow chart of general operation of a CRNN system in accordance with an embodiment;

FIG. 11 is a high-level example of a system for receiving input data and training either an OICR engine or an end user model according to an embodiment;

FIG. 12 is a high level diagram of a portion of a deep learning system for model training according to an embodiment.

FIG. 13 shows a high-level example of a deep learning system for model training according to an embodiment.

### DETAILED DESCRIPTION OF EMBODIMENTS

Aspects of the present invention provide, in an optical/image character recognition (OICR) system comprising an OICR engine and a machine learning system, a method of training the machine learning system, the method comprising: receiving input text and/or image data; altering the input text and/or image data to produce degraded data; training the machine learning system using the degraded data; receiving the degraded data into the machine learning system; correcting the degraded data with the machine learning system to produce corrected data; in response to detecting that adjustment of the machine learning system is required after reading the corrected data, adjusting one or more weights of nodes in the machine learning system; and repeating the correcting and adjusting until it is determined that adjustment no longer is required; wherein the adjusting is carried out without requiring refinement or other alteration to the OICR engine.

In a further aspect, the machine learning system uses additional data besides the degraded data for training. In a still further aspect, the machine learning system is a convolutional recurrent neural network (CRNN), the CRNN comprising a convolutional neural network (CNN) and a recurrent neural network (RNN). In a yet still further aspect, the CNN produces the degraded data, and the RNN produces the corrected data. The CNN may be trained with generative adversarial network (GAN) loss, and the RNN may be trained with connectionist temporal categorical (CTC) loss.

Other aspects of the present invention provide, in an optical/image character recognition (OICR) system comprising an OICR engine and a machine learning system, a method of restoring degraded data, the method comprising, in the machine learning system: receiving the degraded data; correcting the degraded data with the machine learning system to produce corrected data; in response to detecting that adjustment of the machine learning system is required after reading the corrected data, adjusting one or more weights of nodes in the machine learning system; and repeating the correcting and adjusting until it is determined that adjustment no longer is required. In a further aspect, the degraded data comprises characters with one or more of merged or missing strokes and background noise. In a still further aspect, the method includes, responsive to a determination that contents of the machine learning system warrant incorporation of one or more aspects of the machine learning system into to the OICR system, making changes to the OICR system to incorporate the one or more aspects. In a yet still further aspect, the machine learning system is a convolutional recurrent neural network (CRNN), the CRNN comprising a convolutional neural network (CNN) and a recurrent neural network (RNN). In embodiments, the CNN produces the degraded data, and the RNN produces the corrected data.

Still other aspects of the present invention provide an optical/image character recognition (OICR) system comprising an OICR engine and a machine learning system, wherein the machine learning system is programmed to perform a method comprising: receiving input text and/or image data; altering the input text and/or image data to produce degraded data; training the machine learning system using the degraded data; receiving the degraded data into the machine learning system; correcting the degraded data with the machine learning system to produce corrected data; in response to detecting that adjustment of the machine learning system is required after reading the corrected data, adjusting one or more weights of nodes in the machine learning system; and repeating the correcting and adjusting until it is determined that adjustment no longer is required; wherein the adjusting is carried out without requiring refinement or other alteration to the OICR engine. In a further aspect, the machine learning system uses additional data besides the degraded data for training. In a still further aspect, the machine learning system is a convolutional recurrent neural network (CRNN), the CRNN comprising a convolutional neural network (CNN) and a recurrent neural network (RNN). In embodiments, the CNN produces the degraded data, and the RNN produces the corrected data. In yet still further aspects, the CNN is trained with generative adversarial network (GAN) loss, and the RNN is trained with connectionist temporal categorical (CTC) loss.

Still other aspects of the present invention provide, in the machine learning system, a method of restoring degraded data, the method comprising: receiving degraded end user data; correcting the degraded end user data with the machine learning system to produce corrected end user data; in response to detecting that adjustment of the machine learning system is required after reading the corrected end user data, adjusting one or more weights of nodes in the machine learning system; repeating the correcting and adjusting until it is determined that adjustment no longer is required; and outputting the corrected end user data. According to additional aspects, the degraded data end user comprises characters with one or more of merged or missing strokes and background noise. According to yet additional aspects, responsive to a determination that contents of the machine learning system warrant incorporation of one or more aspects of the machine learning system into to the OICR system, changes to the OICR system are made to incorporate the one or more aspects. According to yet still additional aspects, the machine learning system is a convolutional recurrent neural network (CRNN), the CRNN comprising a convolutional neural network (CNN) and a recurrent neural network (RNN). In embodiments, the CNN produces the degraded data, and the RNN produces the corrected data.

As noted earlier, according to an embodiment, the inventive method and system described herein has particular applicability to Eastern language character generation and restoration. In an embodiment, the inventive method and system performs character generation and restoration in Japanese. In an embodiment, a Convolutional Recurrent Neural Network (CRNN) learns and separate two levels of information: (1) noise or other degradation in printed text; (2) high level font or handwriting content.

In an embodiment, a Convolutional Neural Network (CNN) addresses noise in an earlier stage. At a later stage, a Recurrent Neural Network (RNN) learns high-level font information. In an embodiment, the overall Convolutional-Recurrent neural network (CRNN) is trained with a specific loss function, including a loss for an associated Generative Adversarial Network (GAN) for the CNN, and a Connectionist Temporal Categorical (CTC) loss for the RNN. As ordinarily skilled artisans will appreciate, each loss function is associated with a particular instance.

There are several aspects of the CRNN according to different embodiments. In one aspect, the CRNN generates text and/or images that are degraded to provide degraded images resembling images in end user data. To generate the degraded images, a font may be selected. Degradations may have different effects depending on the font.

In another aspect, the CRNN restores text and/or images from input degraded images. The generated degraded images in the first-described aspect may be used to train the CRNN to recognize what is deficient or missing in the input degraded images.

In an embodiment, the CRNN receives a noisy sample, or an image template to train the network to recognize characters. The network outputs a new image with the content maintained from an input image.

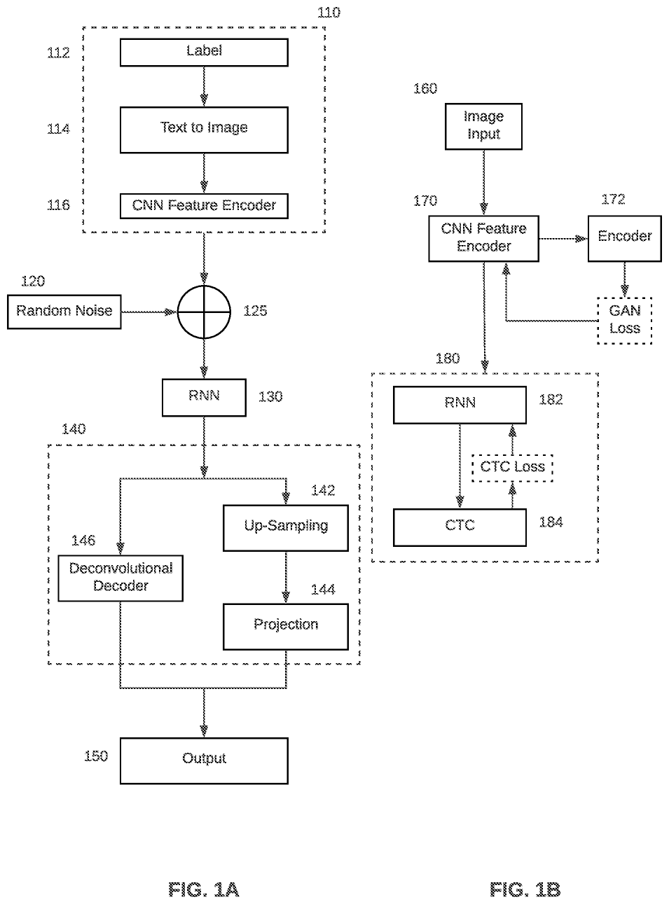

FIGS. 1A and 1B show a CRNN based Generative Network according to an embodiment. In FIG. 1A, generator module 110 generates text which is to be degraded in a manner to be described. In generator module 110, labeling module 112 describes the content that is being input. At 114, the appropriate text or image data is generated based on the output of labeling module 112. CNN feature encoder 116 takes the data and generates appropriate feature sets. The CNN learns low-level features such as noise pattern or style. In the case of text, in an embodiment the CNN may learn font shapes (e.g. sharpness, roundness).

Next, the feature sets from CNN feature encoder 116 are combined, with various types of data that will degrade the feature sets, at combiner 125. In an embodiment, random noise block 120 provides the degradation features. RNN 130, which receives the results of combiner 125 as degraded text, preserves content in the generated images/degraded text.

Generative network 140 receives an output of RNN 130 and provides an output 150 comprising degraded characters or text. As FIG. 1B shows, generative network 140 includes a deconvolutional decoder 146, an upsampling module 142, and a projection module 144 (the modules 142 and 144 together being referred to as an upsampling projector). The deconvolutional decoder 146 may create high level information about data it receives as input. Upsampling projector 142/144 may preserve some features of the data, as well as some basic content styles.

In an embodiment, within generative network 140, deconvolutional decoder 146 preserves basic content of the characters. For example, in an embodiment the deconvolutional decoder 146 may respond to the input of the degraded characters or text by providing corresponding generally universal characters, which may have the basic shape, but which may lack particulars of appearance such as font. Upsampling projector 142/144 may add specific features, such as sharpness or roundness of font. As a result of the operations of generative network 140, then, the resulting generated/restored image will resemble the target image, or ground truth.

FIG. 1B shows part of a discriminator module, which learns to distinguish between generated data and real data. In FIG. 1B, at 160, text or images of characters to be restored are input. In an embodiment, the output 150 in FIG. 1A may feed directly into image input 160. Data from image input 160 goes to a CNN feature encoder 170, which generates appropriate feature sets, which in turn pass into content preserving module 180. The discriminator module may discern that the data being input at image input 160 is generated data rather than real data. The determination of generated data rather than real data is reflected as GAN loss, which then is used to train the CNN at encoder 172. Content preserving module 180 includes RNN 182, which preserves content in restored images, and CTC block 184. CTC loss coming out of CTC block 184 is used to train the RNN.

In an embodiment, the network of FIGS. 1A and 1B may be a competitive poor and rich optimized (CPRO) based deep learning model.

In an embodiment, degraded samples, such as might appear in the dataset of an end user, are generated. These degraded samples can be used, if necessary, to finetune the OICR engine to improve its performance. Such synthetic data generation is in contrast to current synthetic data generation, which requires identification of noise patterns, and application of existing fonts. The process thus is simpler, and provides end-to end learning for synthetic data generation and augmentation. In an embodiment, the process may even be automated and integrated into the OICR engine finetuning and retraining process itself to support a specific end user data and requirement. Such integration may occur for certain end users who have a significant amount of overlap between their specific requirements, as the CRNN system might meet, and the OICR engine itself.

In the CRNN, a CRNN encoder-decoder is employed to maintain content information throughout the training process. GAN loss learns low-level noise patterns so as to be able to separate the noise from the content. As a result, there is better control over levels of degradation in the generated samples. This improved control helps to avoid prevents shifting of the training data distribution and damaging the overall capability of the OICR engine because of potential for things like drift.

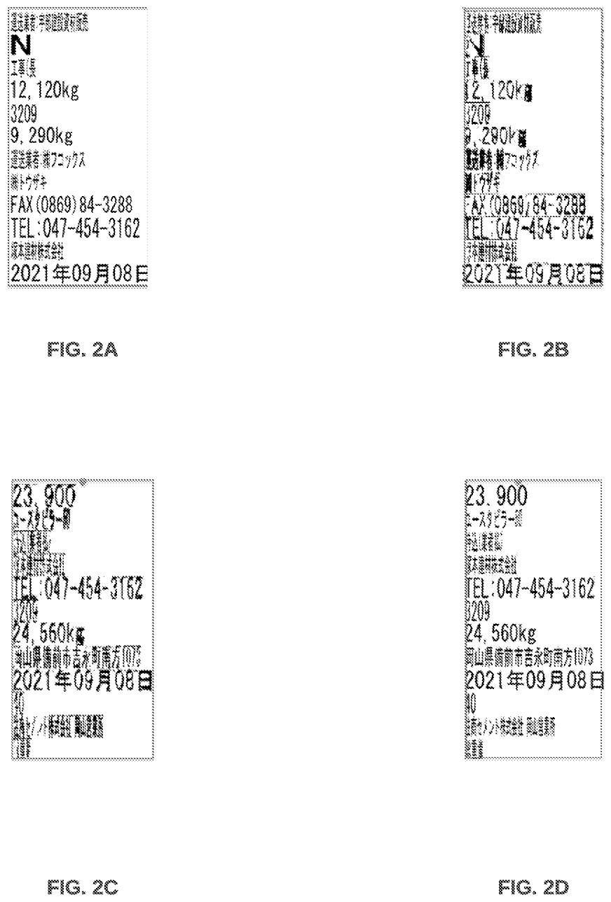

FIGS. 2A and 2B show an example of data augmentation in accordance with an embodiment. FIG. 2A is an input image which is generated digitally, using a template for a relevant font. FIG. 2B is an output with character degradation that the system has provided. Various smudges and blurs, and even largely missing characters may be seen in FIG. 2B as compared with FIG. 2A.

FIGS. 2C and 2D show an example of data restoration in accordance with an embodiment. FIG. 2C is an input image containing damaged characters, taken from actual data. FIG. 2D is an image containing characters which are restored from the input image.

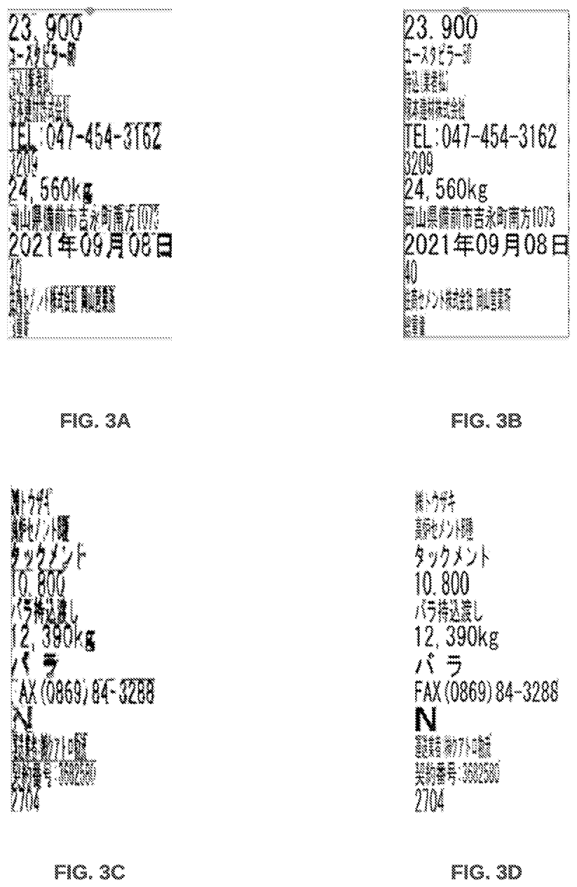

FIGS. 3A and 3B, and FIGS. 3C and 3D, are examples of image restoration. FIG. 3A is input text, including smudged or blurred characters in a number of the rows, as well as words with missing characters in several of the rows. FIG. 3B is text as restored by CRNN system. It is easy to see that missing or largely incomplete characters have been filled in, and smudged or blurred characters appear considerably more clearly. Thus, according to an embodiment, missing portions of image data can be added, and extraneous background and surrounding data can be removed.

Similarly to FIGS. 3A and 3B, FIG. 3C is input text, and FIG. 3D is text as restored by the engine. In an embodiment, longer strings of data can provide context to the CRNN to provide more information for the restoration of missing, smudged, or blurred image data.

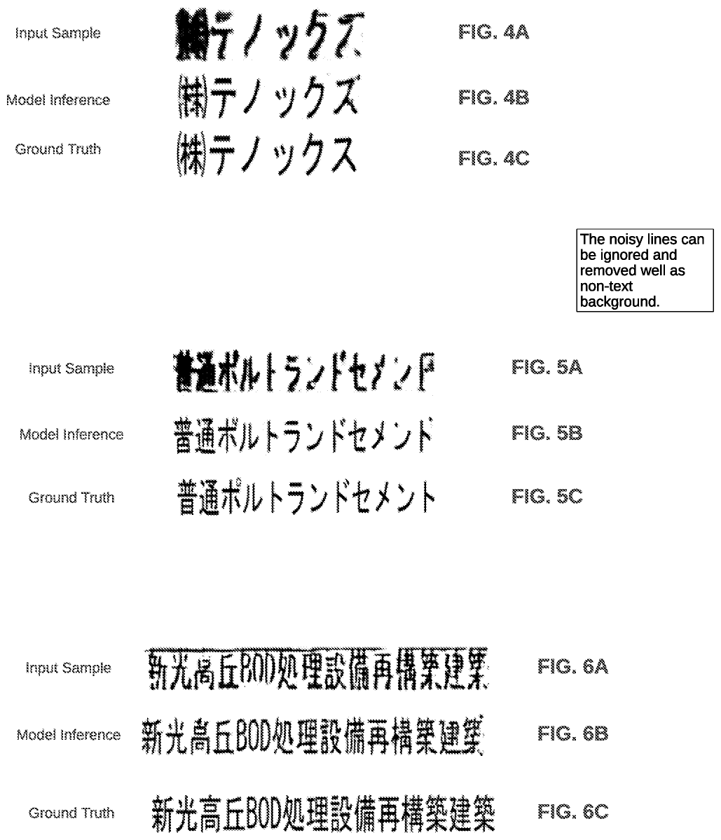

FIGS. 4A-4C show an input sample, a model inference, and a ground truth according to an embodiment. In FIG. 4A, the first character on the left hand side is very seriously smudged. FIG. 4B shows the result of application of the CRNN system in accordance with an embodiment. All of the characters, especially the first character on the left hand side, are much clearer. FIG. 4B compares favorably with FIG. 4C, which is ground truth, or how the image actually should appear, including the font.

FIGS. 5A-5C show a further sample, model inference, and ground truth according to an embodiment. In FIG. 5A, all of the characters, especially the two characters on the left, are very blurry. FIG. 5B shows much clearer versions of the characters in FIG. 5A.

FIGS. 6A-6C show a further sample, model inference, and ground truth according to an embodiment. In FIG. 6A, there are markings that appear over or on top of the input image data, and which FIG. 6B shows have been removed. Similarly to FIGS. 4C and 5C, FIG. 6C represents ground truth.

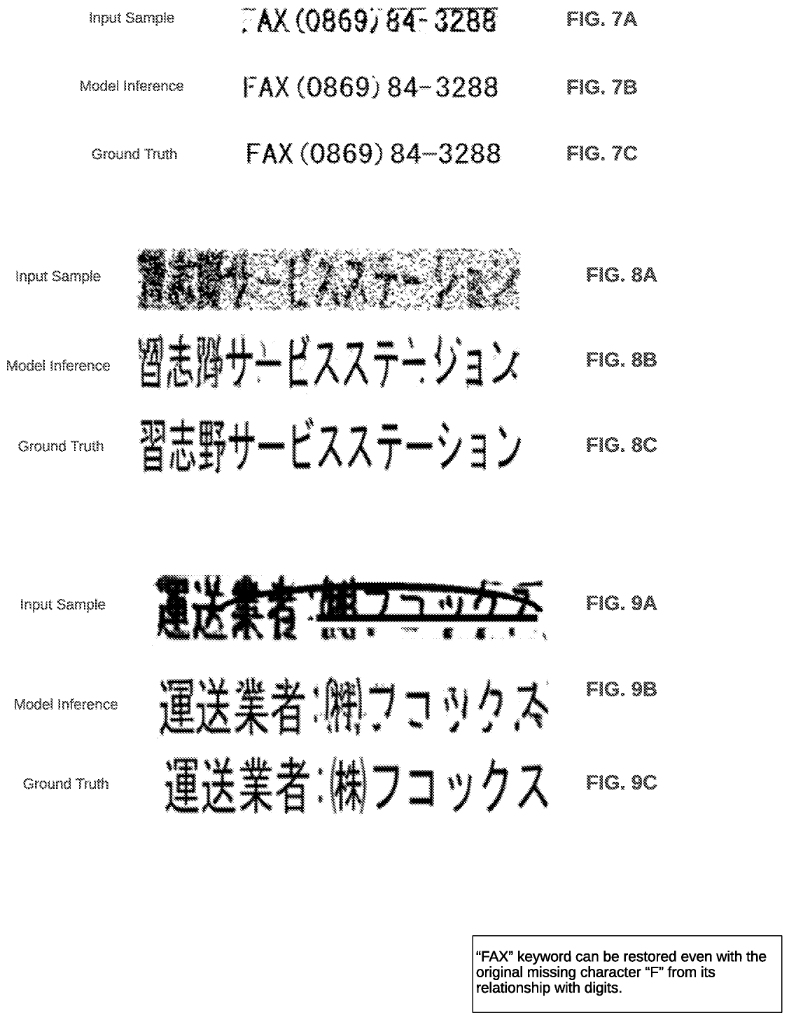

FIGS. 7A-7C show a further sample, model inference, and ground truth according to an embodiment. These figures show an example of an ability to replace a character (here, the “F” in “FAX”) which is almost completely missing in FIG. 7A, but which is largely replaced in FIG. 7B. The “F” is clearly legible. Here again, FIG. 7C represents ground truth.

FIGS. 8A-8C show a further input sample, a model inference, and a ground truth according to an embodiment. FIG. 8A shows a quite heavy background, such that the characters do not appear as readily distinguishable. FIG. 8B shows the background removed, and the underlying characters reproduced. Without being bound by any theory, it is possible that when the CRNN system learns how to distinguish background from the characters, and can remove the background, the characters themselves may be easier to reproduce. It also is possible that the context in which the characters appear informs the correct identification of characters. A comparison of FIG. 8B with the ground truth of FIG. 8C shows good, but not perfect reproduction, particularly as it pertains to the character farthest to the left.

FIGS. 9A-9C show a further sample, a model inference, and a ground truth according to an embodiment. In FIG. 9A, in addition to blurriness of characters on the left hand side, there are thick marks appearing across almost all of the characters. Here, again without being bound by any particular theory, it is possible that the sequence in which the characters appear can inform what the characters are, even when the characters are blurry. Knowing how the characters should appear may make it easier to remove the thick marks that appear. Alternatively, partially removing the remarks may facilitate deciphering the characters. FIG. 9B shows quite good agreement with the ground truth in FIG. 9C.

In an embodiment, depending on the location of the data in a particular field, or on the characters immediately around the damaged letter, the surrounding data may inform the CRNN of the correct identity of the damaged letter.

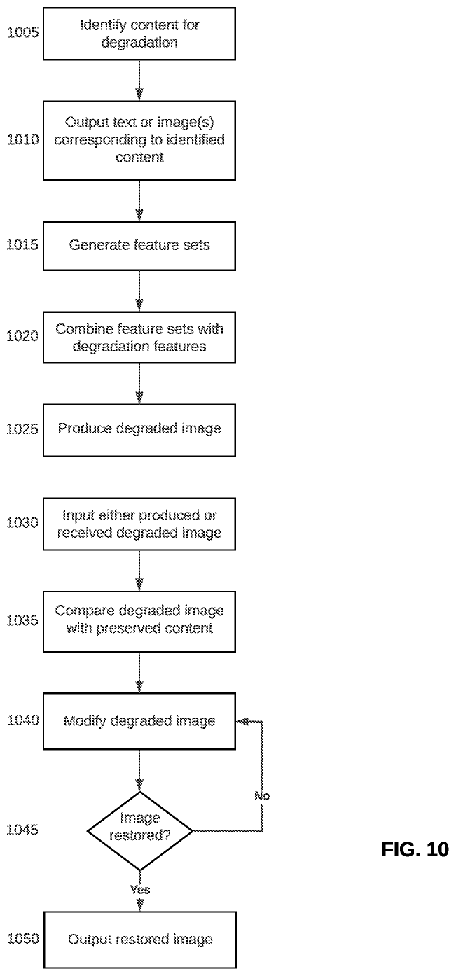

FIG. 10 provides a high level overview of flow in a CRNN system according to an embodiment. At 1005, content to which degradation is to be applied is identified, and at 1010, the text or image (s) corresponding to that identified content is output. At 1015, appropriate feature sets are generated based on the output text/image(s). At 1020, the feature sets are combined with other data (e.g. random noise, background coloring, or the like), and at 1025, content with the degradation features (degraded text) is output. This content is preserved. The feature sets may be retained for use in restoring the text.

At 1030, in an embodiment, degraded text (whether resulting from 1005-1025 or from actual degraded text to be corrected) is provided to an encoder (such as CNN feature encoder 170 in FIG. 1B). At 1035, a comparison between the degraded text (generated data) and real data, reflected as GAN loss, may be used to train the CNN feature encoder. At 1040, data restoration is provided by looking to preserve content in restored images. In restoring the data, smudged or blurred data may be cleaned up, as in FIGS. 4A and 5A; incomplete data, such as in FIG. 7A, may be completed; background color or other background noise may be removed, such as in FIG. 8A; and/or extraneous marks in the middle of the data may be removed, as in FIG. 9A. The filling in of missing data and the removal of extraneous background or foreground in the course of content preservation (such as in content preservation module in FIG. 1B) may be part of the analysis of the input image text.

At 1045, a check is made to determine whether the image has been restored. If not, flow returns to 1040 for further modification. Once the image has been restored, at 1050, the restored image is output.

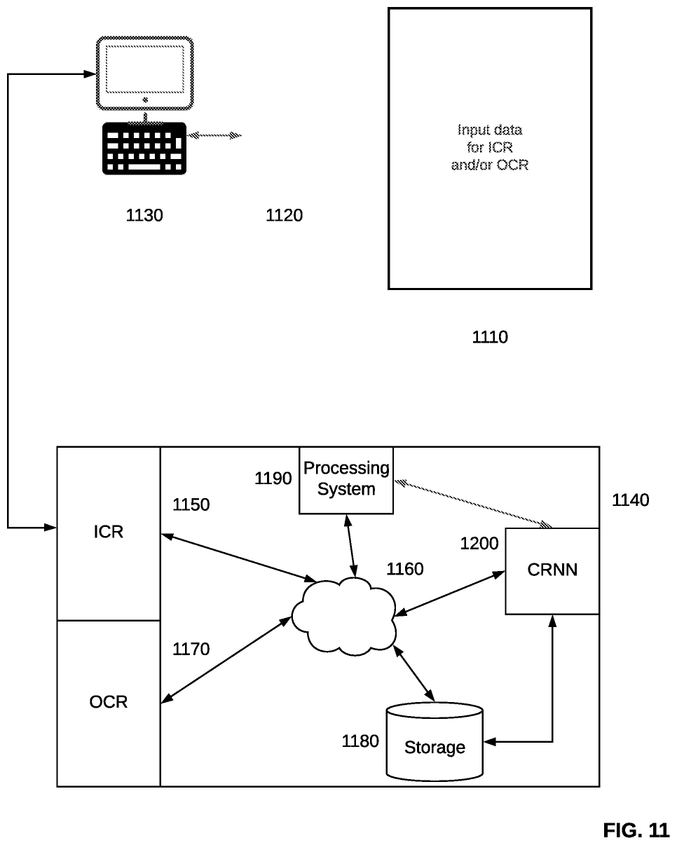

FIG. 11 is a high-level diagram of a CRNN system according to an embodiment. In FIG. 11, input text 1110 may be provided via a scanner or other input device 1120 to an ICR module 1150 or OCR module 1170 depending on the text recognition process to be carried out. A processing system 1140 may include a processing module 1190, which may communicate with either ICR module 1150 or OCR module 1170 as appropriate or necessary to provide requisite processing power, via one or more central processing units (CPUs) or graphics processing units (GPUs) and associated non-transitory storage and/or non-transitory memory. In an embodiment, processing system 1140 may communicate directly with either computer 1130 or scanner/input device 1120. Processing system 1140 may be self-contained, or may have its various elements connected via a network or cloud 1160. One or both of ICR module 1150 or OCR module 1170, each of which may have its own CPUs and/or GPUs, may communicate with processing module 1190 via the network or cloud 1160.

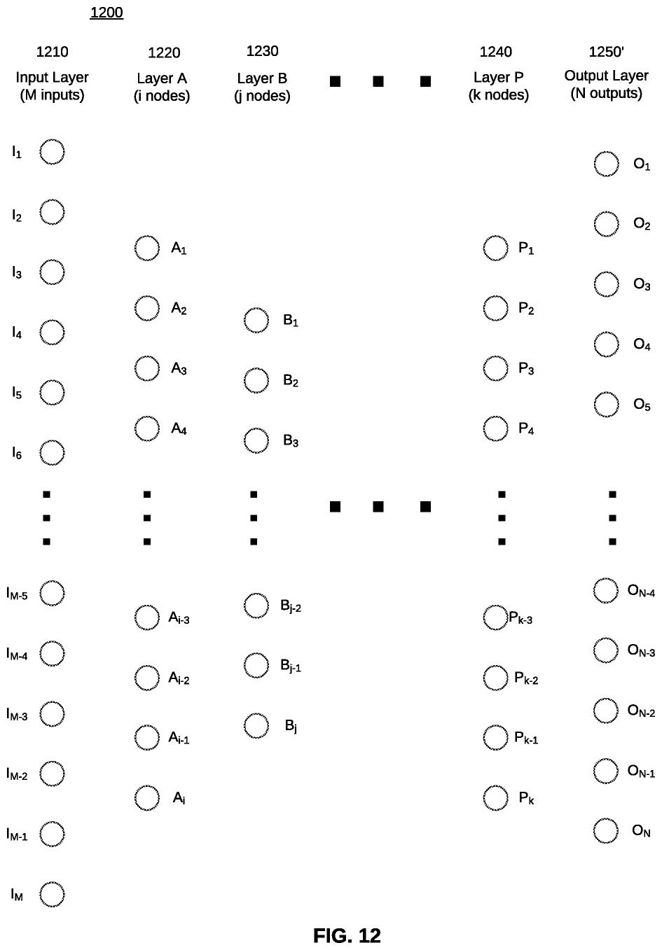

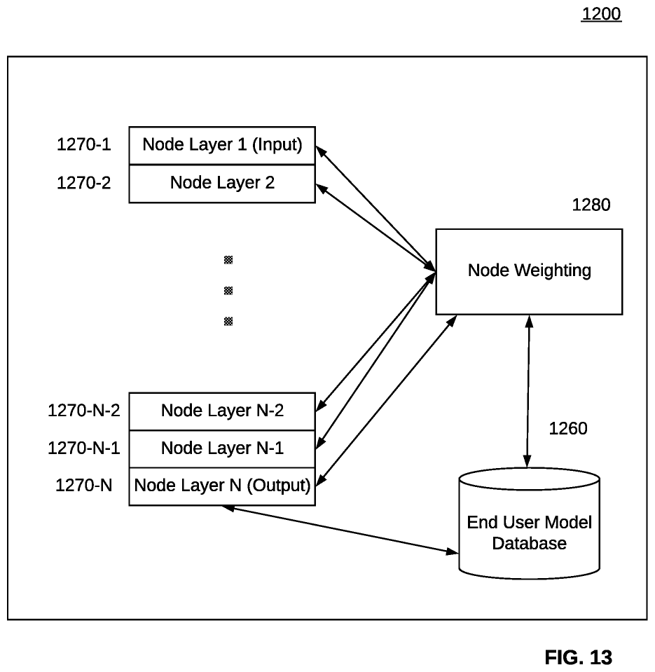

The various elements in processing system may communicate with CRNN 1200, which will be described in more detail below with reference to FIGS. 12 and 13.

FIG. 12 is a high-level diagram of node layers in a CRNN 1200 according to an embodiment. In FIG. 12, CRNN 1200 has an input layer 1210 comprising a plurality of nodes. Depending on the system, there may be one or more intermediate layers 1220-1240 (FIG. 12 shows P such layers, where P is a positive integer), each of the intermediate layers in turn comprising a plurality of nodes. The last layer 1250 provides the output. In an embodiment, as ordinarily skilled artisans will appreciate, training the CRNN 1200 involves assigning weights to the various nodes in the various layers, based on input training data for a particular end user.

FIG. 13 shows a little more detail of the CRNN 1200. Model database 1260 stores weights and data. Node weighting module 1270 calculates weights for the various nodes in the various layers based on comparison with results, among other things, and assigns those weights to layers 1270-1, 1270-2, . . . 1270-N−2, 1270-N−1, 1270-N accordingly.

In an embodiment, as noted earlier, the CRNN 1200 and the OICR engine both could be deep learning systems. In an embodiment, the CRNN 1200 and the OICR engine could share one or more of the layers of nodes in FIG. 12. In such an embodiment, the CRNN system would manage the layer(s) of nodes specific to CRNN 1200, and would not affect any node layers of the OICR engine.

While the foregoing describes embodiments according to aspects of the invention, the invention is not to be considered as limited to those embodiments or aspects. Ordinarily skilled artisans will appreciate variants of the invention within the scope and spirit of the appended claims.

What is claimed is:

1. In an optical/image character recognition (OICR) system comprising an OICR engine and a machine learning system, a method of training the machine learning system, the method comprising:
receiving input text and/or image data;
altering the input text and/or image data to produce degraded data;
training the machine learning system using the degraded data;
receiving the degraded data into the machine learning system;
correcting the degraded data with the machine learning system to produce corrected data;
in response to detecting that adjustment of the machine learning system is required after reading the corrected data, adjusting one or more weights of nodes in the machine learning system; and
repeating the correcting and adjusting until it is determined that adjustment no longer is required;
wherein the adjusting is carried out without requiring refinement or other alteration to the OICR engine.

2. The method of claim 1, wherein the machine learning system uses additional data besides the degraded data for training.

3. The method of claim 1, wherein the machine learning system is a convolutional recurrent neural network (CRNN), the CRNN comprising a convolutional neural network (CNN) and a recurrent neural network (RNN).

4. The method of claim 3, wherein the CNN produces the degraded data, and the RNN produces the corrected data.

5. The method of claim 3, wherein the CNN is trained with generative adversarial network (GAN) loss, and the RNN is trained with connectionist temporal categorical (CTC) loss.

6. In an optical/image character recognition (OICR) system comprising an OICR engine and a machine learning system, a method of restoring degraded data, the method comprising, in the machine learning system:
receiving the degraded data;
correcting the degraded data with the machine learning system to produce corrected data;
in response to detecting that adjustment of the machine learning system is required after reading the corrected data, adjusting one or more weights of nodes in the machine learning system; and
repeating the correcting and adjusting until it is determined that adjustment no longer is required.

7. The method of claim 6, wherein the degraded data comprises characters with one or more of merged or missing strokes and background noise.

8. The method of claim 6, further comprising, responsive to a determination that contents of the machine learning system warrant incorporation of one or more aspects of the machine learning system into to the OICR system, making changes to the OICR system to incorporate the one or more aspects.

9. The method of claim 6, wherein the machine learning system is a convolutional recurrent neural network (CRNN), the CRNN comprising a convolutional neural network (CNN) and a recurrent neural network (RNN).

10. The method of claim 9, wherein the CNN produces the degraded data, and the RNN produces the corrected data.

11. An optical/image character recognition (OICR) system comprising an OICR engine and a machine learning system, wherein the machine learning system is programmed to perform a method comprising:
receiving input text and/or image data;
altering the input text and/or image data to produce degraded data;
training the machine learning system using the degraded data;
receiving the degraded data into the machine learning system;
correcting the degraded data with the machine learning system to produce corrected data;
in response to detecting that adjustment of the machine learning system is required after reading the corrected data, adjusting one or more weights of nodes in the machine learning system; and
repeating the correcting and adjusting until it is determined that adjustment no longer is required;
wherein the adjusting is carried out without requiring refinement or other alteration to the OICR engine.

12. The system of claim 11, wherein the machine learning system uses additional data besides the degraded data for training.

13. The system of claim 11, wherein the machine learning system is a convolutional recurrent neural network (CRNN), the CRNN comprising a convolutional neural network (CNN) and a recurrent neural network (RNN).

14. The system of claim 13, wherein the CNN produces the degraded data, and the RNN produces the corrected data.

15. The system of claim 13, wherein the CNN is trained with generative adversarial network (GAN) loss, and the RNN is trained with connectionist temporal categorical (CTC) loss.

16. The system of claim 11, wherein the method further comprises, in the machine learning system, a method of restoring degraded data, the method comprising:
receiving degraded end user data;
correcting the degraded end user data with the machine learning system to produce corrected end user data;
in response to detecting that adjustment of the machine learning system is required after reading the corrected end user data, adjusting one or more weights of nodes in the machine learning system;
repeating the correcting and adjusting until it is determined that adjustment no longer is required; and
outputting the corrected end user data.

17. The system of claim 16, wherein the degraded data end user comprises characters with one or more of merged or missing strokes and background noise.

18. The system of claim 16, further comprising, responsive to a determination that contents of the machine learning system warrant incorporation of one or more aspects of the machine learning system into to the OICR system, making changes to the OICR system to incorporate the one or more aspects.

19. The system of claim 16, wherein the machine learning system is a convolutional recurrent neural network (CRNN), the CRNN comprising a convolutional neural network (CNN) and a recurrent neural network (RNN).

20. The system of claim 19, wherein the CNN produces the degraded data, and the RNN produces the corrected data.
